(19) United States
(12) Patent Application Publication
(10) Pub. No.: US 2008/0077493 A1
(43) Pub. Date: Mar. 27, 2008

(54) Project Based Tracking System and Method

(75) Inventor: William Geffert, Clearwater, FL (US)

Correspondence Address: NEIFELD IP LAW, PC, 4813-B EISENHOWER AVENUE, ALEXANDRIA, VA, 22304, US

(73) Assignee: CATALINA MARKETING CORPORATION, ST. PETERSBURG, FL (US)

(21) Appl. No.: 11/831,584

(22) Filed: Jul. 31, 2007

Related U.S. Application Data
(60) Provisional application No. 60/836,971, filed on Aug. 11, 2006.

(51) Int. Cl. G06Q 30/00

(52) U.S. Cl. 705/14

(57) ABSTRACT

Novel computer implemented methods, systems, and architectures assist the consumer in categorizing the consumer's product purchase data and enabling marketers access to that categorization for us in targeting communications to the consumer.

### CROSS REFERENCE TO RELATED APPLICATIONS

This application claims benefit to 60/836,971, filed Aug. 11, 2006, having attorney docket number P1P181GEFFP-US ENTITLED “Project Based Tracking System and Method”.

### FIELD OF THE INVENTION

This invention relates to the field of retail store technology.

### BACKGROUND OF THE INVENTION

Retail store technology exists for recording purchases in the store in association with a consumer identification, and using the consumer identification to associate products purchase in association with the same consumer identification in different transactions with one another.

Acronyms Used Here In
RS—Retail store.
MRID—Machine readable identification.
POS CS—Point of sale computer system.
CS—Computer system.
ID—Identification
PID—Product identification.
UPC—Universal product code.
CID—Consumer identification.
PDA—Personal digital assistant
POS—Point of sale
PVC—Polyvynilchloride
I/O—input output
RSID—Retail store identification
URL—Universal resource locator
CPU—Central processing unit.

Definitions Used Here in
Recipe—A list of products and optionally a procedure for using those products.
Category—A description to which one or more recipes are associated.
XID—An identifier.
XXID—An identifier used to associate with one another two or more other identifiers.

### SUMMARY OF THE INVENTION

Object of the Invention

It is one object to provide a consumer the ability to access and organize their product purchase information.

It is another object to provide to retailers, marketers, and service providers access to the consumer's organization of the consumer's information to better target communications to the consumer.

The present inventor recognized that associating all products purchased by a consumer with that consumer did not identify, for targeted marketing purposes, subjective consumer associations of certain products with one another. The present inventor conceived of novel computer implemented methods and architectures to assist the consumer in categorizing the consumer's product purchase data and enabling marketers access to that categorization.

The inventor provides systems and methods that store a consumer's purchase history data wherein PIDs are stored in associations set up by the consumer with categories and recipes. Recipes are also referred to here in as projects.

The inventor conceives of systems and methods in which a consumer obtains an identification that can be used as an association with a category or project, referred to herein as a machine readable identification, MRID because in some embodiments the MRID is stored on a machine readable memory in an identification card. The consumer selects which PIDs of products the consumer purchases in a store to associate with the MRID. The consumer may select which PIDs to associate with an MRID either by having his MRID card read at a store checkout in association with the PIDs begin purchased, or by using a web site to which the consumer can log. The consumer can (using an appropriate computerized device) log in to the web site using a log in code (an XID) uniquely related to the consumer's MRID or CID, and optionally an identification of a store associated with that XID. The back end database of the web site stores the consumer's purchase data. The consumer can, after log in on to that web site, interact with the web site, review the categorization and change the categorization of the consumer's purchase data (by category and sub category or recipe), which categorizations are then saved in the back end database. The categorization information can then be used in target marketing algorithms that determine what information (marketing, coupons, advisories) to subsequently provide to the consumer.

In operation, a store's CS (typically, a POS CS that manages the inventory and transaction data for the store) logs transaction data for a purchase by the consumer including the consumer's MRID, UPCs indicating product items (also referred to herein as Product IDs, PIDs), quantity of each product item, price of each product item, and stores that information in addition to other information, such as date and time, in computer memory.

The purchase transactions data for one or more stores of one or more retail organizations are stored in a master database. The master database is linked to a web site run by a CS, typically a central CS different from the POS CS. The web site allows the customer to log on using a code (XID) uniquely associated with the customer's MRID for the retail store or chain of retail stores. The consumer's submission to the web site of the XID code uniquely associated with the customer's MRID for the retail store allows the central CS to identify those records in the master database for the consumer's purchases in that retail store or chain of stores; those associated with the corresponding MRID. The XID code may be the same or different from the customer's CID or MRID. However, for security purposes, it preferably is different from the CID or MRID and stored in association with the CID or MRID in the store's CS and the central CS's database.

Preferably, someone at the retail store or the store's CS communicates to the consumer the code uniquely associated with the customer's MRID for that retail store. For example, the RS POS CS may print an XID code at checkout when the consumer is at checkout. The XID code may be linked in a file accessible to the central CS with the consumer's MRID.

Alternatively, the RS CS may run the aforementioned web site and have a master database storing purchase data for only purchases in that store or in a chain of co-owned stores. In either case, the aforementioned structure enables the consumer to access all PID (UPC) and product descriptions thereof stored in association with the XID. The consumer may do so via a kiosk in the store or via a personal computer, PDA, or cell phone located anywhere. The web site interacting with the database provides for a log in based upon the MRID from a personal computer, PDA, or cell phone.

The web site in conjunction with the master database and code allow the consumer to associate or change associations of the consumer's purchases with categories and preferably create categories and their descriptions. As a result, the consumer obtains the ability to track purchases related to a project, such as a construction project, a home repair or remodeling project, a birthday party project, a meeting, or any other categorization the consumer selects. In addition, the consumer may re-organize the category and product—project associations, before or after purchase of the identified products, using this interface. The consumer may associate a project category or name with each such project, and store that information on a server or store computer system. The classifications may also be hierarchal, such as a category for hardware, and under that category sub categories for projects like drywall repair, fence installation, or the like.

MRID cards, prior to distribution to consumers, may be physically associated (such as glued or stapled or packaged) with a listing in printed information of a recipe of items typically needed for a certain type of project, and the MRID associated with a card may have in a computer database a default category or project associated therewith. Cards whose MRID's are associated in a database with a certain type of project may be situated in a retail store in a department of the retail store having at least one of the items specified in the associated recipe for completing that type of project.

When a consumer checks out of a retail store (purchases items from the store), the consumer may present a card having an MRID, such as the MRID for the items associated with the project. The consumer may also or instead present any other CID, such as a credit card or frequent shopper card. Both the MRID and the other CID (if present) are stored in association with the consumer's other purchase data (including at least product identifications, prices, quantities, and transaction total cost).

The association of the customer's CID for all purchased items and MRID for items associated with a project may be used in analysis for future targeting of that consumer for purchase incentive offers. The customer's subsequent changes to associations may also be so used. For example, PIDs associated with a MRID in the consumer's purchases may be excluded from filters identifying purchase behavior used for target marketing, such as purchase incentive offers requiring purchase of a specific product to entitle the purchase to an incentive, such as cents off coupons. This is because the project specific items for a certain types of completed projects are likely not indicators of future behavior unrelated to projects. These projects are of the one time project class, such as a construction project. The consumer's classification of other types or projects may suggest a periodicity to which the project specific purchases are highly time correlated, such as birthday parties (annually correlated), lawn and garden projects (annually or seasonally correlated). Some consumer projects, such as roofing or painting projects, may have a weak long term correlation relating to the average and standard distribution of lifetime for roofing and paint. For these types of projects, targeted marketing by a retail store may commence at a time prior to the anticipated lifetime of the long lifetime result of a project, in order to enhance the consumer's awareness that particular retail store can provide products for a project (such as a second roof repair or re painting) in advance of when such new project is necessary.

Alternatively to presenting an MRID card associated with one project when purchasing products, the consumer may be advised that the consumer can use his existing CID or an XID to log on to a web site and organize his product purchase data by project or category, and optionally assign project and category names, and obtain reports on that data. In other words, the consumer need obtain no additional physical card to obtain access of records of the consumer's purchases for the consumer's personal use. The consumer may be provided a printout containing a code which is associated in a database with the consumer's CID, such as at a POS when the consumer is engaged in a purchase transaction. The consumer's categorization of their purchases may be used as parameters in targeted marketing algorithms in order to decide what and when to present product specific purchase offer incentives and product advertisements to the consumer. Such product specific purchase offer incentives and product advertisements may subsequently be presented to the consumer either via web pages transmitted to the consumer's web browser when the consumer is logged on using the specified code or to the consumer when the consumer's CID or MRID is recognized in a POS as having been read at a POS for an ongoing transaction at a POS.

In another embodiment, the consumer may be able to indicate, via the consumer's web browser, to the web server, links between the consumer's different MRIDs and CIDs for different stores in which the consumer shops, thereby enabling the web server and central CS to provide the consumer combined reports of the consumer's product purchases from different stores using different CIDs for the consumer. With that information, for example, the consumer may compare the consumer's purchases, such as by item and price, from the different stores. The consumer could identify purchases from different stores with the same category, such as a project, or such as food or medicine categories, or obtain other reports. In addition, such linkage by the consumer would identify to the server different purchase history records as being associated with the same consumer. That identification to the web server of CIDs for different retail stores or chains indicating that those CIDs belong to the same consumer would enable the server running target marketing algorithms used to determine target marketing to have a more complete data set for each consumer, thereby generally resulting in more accurate targeting of the consumer. In addition, it would provide that server the ability to select in which store or chain of stores, or which subset, or all of the stores, associated with the CIDs for the customer, to present to the consumer advertising and purchase offer incentives. In addition, it would provide the server the ability to indicate on any such purchase offer incentive which stores would accept the offer.

The system includes a RS CS that is or includes a POS CS including a central digital data processor, memory, input output (I/O) devices including POS terminals, printers, and scanners. The system optionally includes a central CS to which the POS CS transmits data, and which central CS performs data analysis to identify patterns in product-group associations, and determine product purchase incentive offers (such as, when printed, coupons) to associate with a MRID. The product purchase incentive offers may be transmitted back from the central CS to the RS CS and stored therein in a file. Upon a POS terminal of the RS CS reading an MRID or a CID, or a MRID or a CID in conjunction with a PID, the read MRID or CID and optionally the PID are compared for a match with sets of an MRID and a CID optionally with a PID having an associated product purchase incentive offer, for a match. If a match occurs, software generates a representation of the corresponding product purchase incentive offer at the POS terminal for the customer (image display, printed coupon, or the like).

If the consumer associates purchases with a project, pattern recognition algorithms can identify the type of project, and then the remaining not purchased items for that type of project. Once identified with a specified level of certainty, marketing activities can take place to “fill in the gaps” of a project “recipe”. If a consumer defined project has a 90% certainty of being a sprinkler installation, and the purchase activity indicates that only 70% of the required items have been purchased thus far, then purchase incentives or advertisements can be created and printed for the consumer at the point of sale to for the remaining 30% of the products needed for the project. Typically, printing is at the checkout during a transaction in which the consumer is identified via a CID or MRID.

Moreover, the success of historical marketing product suggestions to a “recipe” or template, as measured by actual increased sales against recommended items, allows a computer system to automatically and dynamically improved templates.

Furthermore, once a “project” has been identified either by the consumer indicating its category or by a similarity match against product items in predefined recipes for predetermined projects, the computer system can automatically detect safety issues, warranty issues, or building code issues that were not identifiable for a shopping basket of single items only. For example, if an interior plumbing project is detected, yet PVC pipe is purchased that is not fit for potable water transmission, the system can quickly highlight the safety issue. Similarly, if a roofing project is detected with the wrong type of nails the system can highlight a potential code violation. It may be interesting to note that the consumer can group and report on items specifically to facilitate easier tax treatment processing.

If the consumer associated on the web site several XIDs, then all of the product purchase information for purchase by that consumer from disparate retail stores may be used by targeting algorithms to improve targeting. In addition, in this case, the CS performing the targeting may specify in which of the corresponding store or stores to provide the consumer the resulting targeted information.

Further, system disclosed herein may us algorithms to dynamically and automatically adjust the PIDs associated with projects or recipes, referred to here in as templates. The system may do this, for a specific project, by determining a relatively high correlation of purchase of a specific product whose PID is not yet part of the template for that specific project, and which has a correlation above some predetermined value to purchase by many consumers of products having PIDs in the project template and to PIDs the consumers have associated the specific template. Alternatively, the correlation may be relative to correlation of the purchase of the specific product with purchase of any one or any subset or all products having PIDs in the system, and the specific product is only added to the template if the relative correlation exceeds a predetermined value. Likewise, the system may remove PIDs from the template for the specific project if the predetermined value of the correlation is found to be below a certain value. The correlations discussed herein refer to values obtain for transaction records from a set of consumers, typically a set consisting of at least 1000 consumers' records, and preferable tens of thousands so as to provide small statistical deviations.

For example, if a new plumbing fixture begins to appear in patterns of customer purchases for a detected “plumbing” project template, the system will “learn” to recognize this new plumbing fixture as part of the template. This process reduces the need for manual template updates.

In one aspect, the invention provides a computer network and method of using the network for enabling a consumer to categorize products in the consumer's transaction data and to determine communications for said consumer based at least upon the consumer's categorizations, comprising:

a first RS CS, said first RS CS including at least one CPU for processing data, at least one checkout station for processing purchase transactions by consumers, and memory for storing data for said purchase transactions by said consumers, wherein said data for said purchase transactions includes, in association with one another for each purchase transaction, PIDs for items purchased, price of each item, quantity of each product item purchased, date, and at least one of CID and MRID;

an interface wherein a consumer can use said interface to log in, using an XID code associated in a database with at least one of said CID and said MRID, to thereby access data for only those purchase transactions by said consumer, and wherein said consumer can use said interface to assign and reassign at least one of a category and a recipe to PIDs associated with purchase transactions by said consumer, and said interface is programmed to store the consumer's assignments to a database; and

a targeting algorithm implemented in code on a CS for determining communications for presentation to said consumer, wherein said targeting algorithm depends targeting at least in part upon the consumer's assignments to at least one of category and recipe, of PIDs associated with purchase transactions by said consumer.

### BRIEF DESCRIPTION OF THE FIGURES

The foregoing concepts are embodied in the detailed description with reference to the following figures.

FIG. 1 is a schematic of a network CS;

FIG. 2 is a schematic of a general purpose CS:

FIG. 3 is a schematic of a RS;

FIG. 4. is a schematic of a POS or checkout of the RS;

FIG. 5 is a schematic of a RS CS, including data structures;

FIG. 6 is a schematic of a central CS, including data structures;

FIG. 7 is a plan view of once side of a card storing an MRID;

FIG. 8 is a plan view of a purchase transaction receipt including a XID code;

FIG. 9 is a frontal view of a log screes in a web browser for a web site; and

FIG. 10 is a data screen in a web browser for a web site after log.

### DETAILED DESCRIPTION

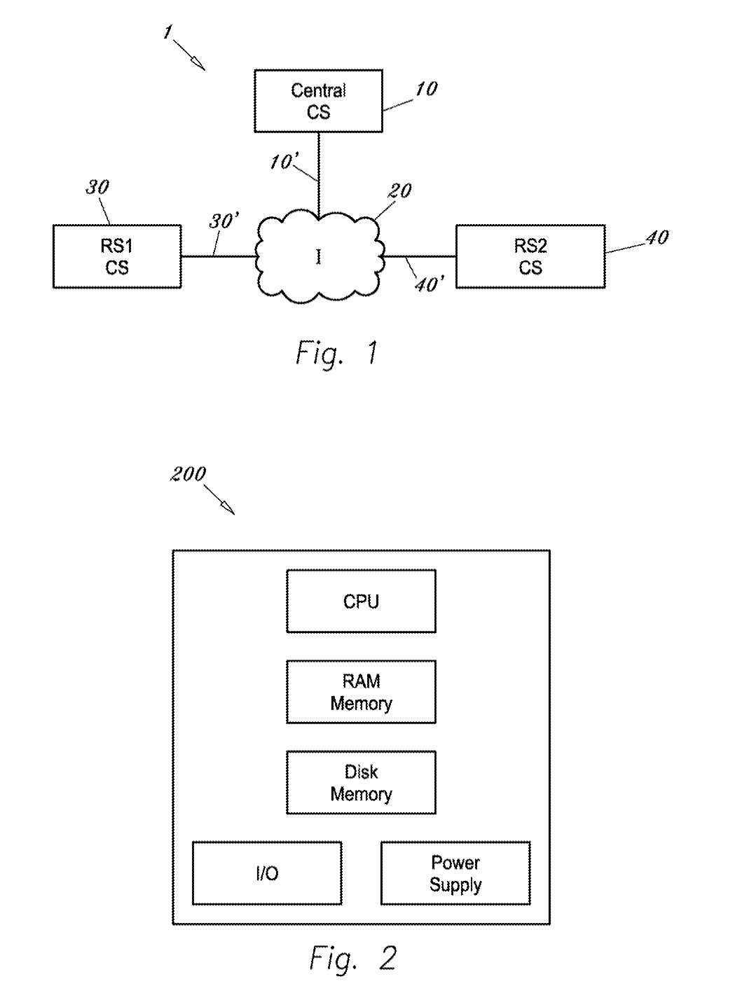

FIG. 1 shows a network including central CS 10, network, such as the Internet, 20, RS1 CS 30 for a first retail store, RS2 CS for a second retail store. Ellipses “ . . . ” indicate the existence of more RS CSs for more retail stores included in network 1. Lines 10′, 20′, 30′, and 40′ indicate network communication links between elements. Each of the CSs disclosed herein may include the elements of a general purpose CS, and additional hardware and software specific for designated tasks.

FIG. 2 shows elements of a general purpose CS including at least a CPU, RAM memory, disk memory, I/O, and a power supply. Conceivably, only one form of memory is required, but both RAM and disk are conventional.

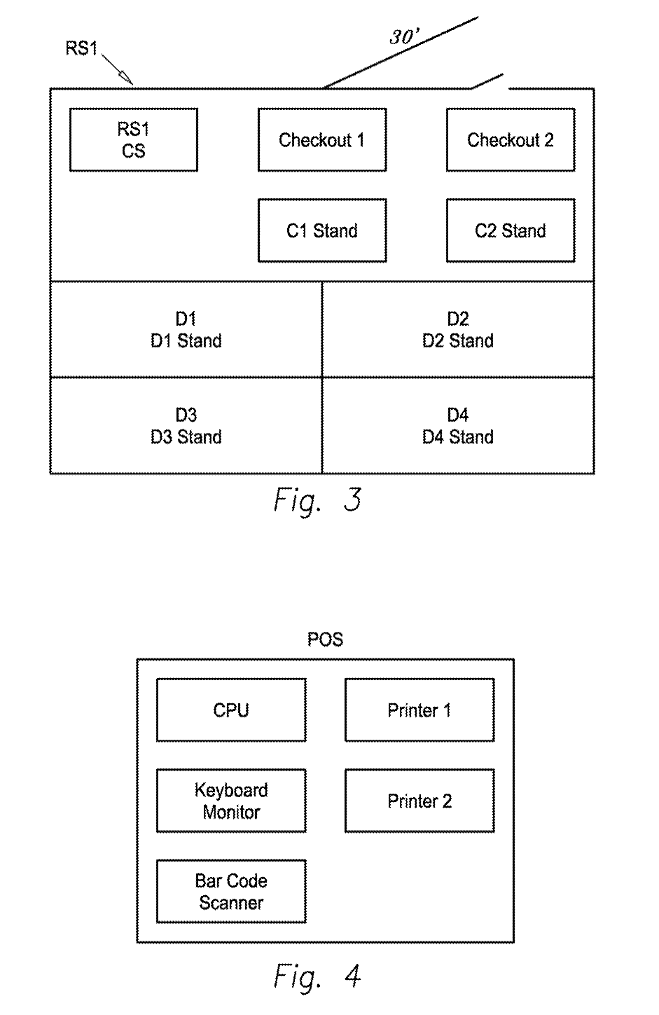

FIG. 3 shows a store configuration having departments located at D1, D2, D3, and D4, in addition to a RS CS and checkouts Checkout1 and Checkout2. In addition, FIG. 3 shows locations of MRID card stands, D1 stand in departments D1, D2 stand in department D2, D3 stand in D3, and D4 stand in D4. In addition, FIG. 3 shows MRID card stands C1 stand near Checkout1, and C2 stand near Checkout2. FIG. 3 shows a door (unnumbered) connected to the store wall adjacent Checkout2. In operation, consumers may pick up cards at the various stands in departments in the store. Cards in each department stand may have their MRID stored in a database in association with a project or category related to that department. Cards in the checkout stands, may have their MRID associated in a database with no category or project.

FIG. 4 shows a POS, such as Checkout1 or Checkout2, including elements forming a smart terminal, such as a CPU, keyboard, monitor, bar code scanner, and printer. FIG. 4 shows printer1 and printer2 because in many implementations a second printer performs printing for marketing, and the first printer performs printing for transaction logs, also referred to as register receipts. However, both printing functions may be performed by a single printer.

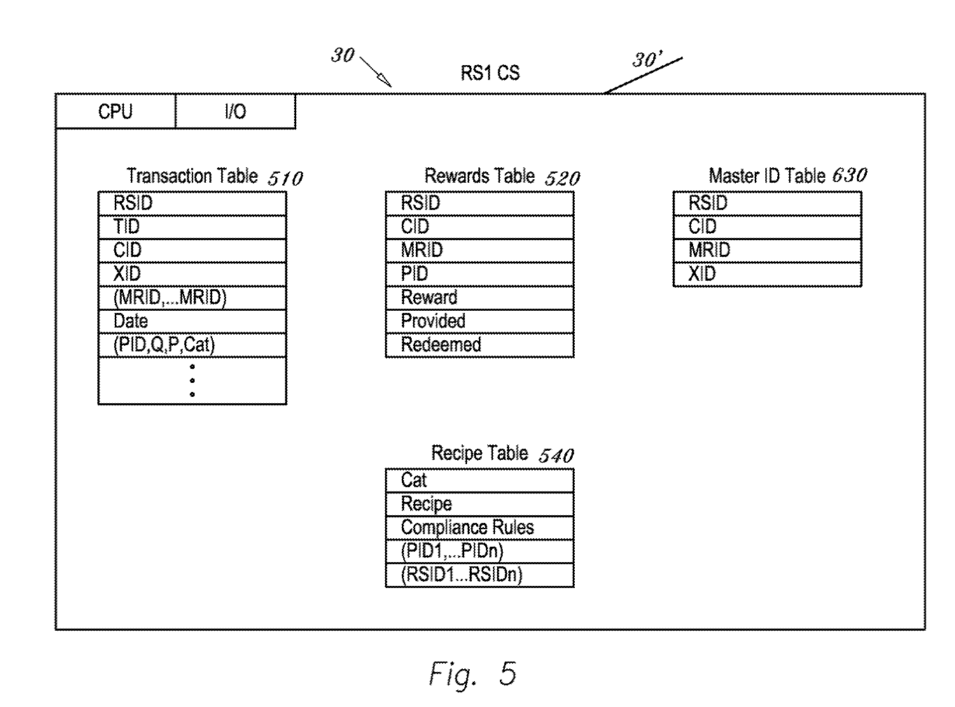

FIG. 5 shows the computer system for a first retail store, RS1 CS. RS1 CS includes a CPU and I/O, and also a database. The database includes tables storing transaction data, rewards data, IDs data, and Recipes data. The database stores other information not relevant here, including stock and other business records.

Transaction table 510 is shown in design view. Table 510 shows that it stores in association with one another the following data fields:
RSID—Retail Store ID (this field is optional)
TID—Transaction ID (typically assigned by RS1 ID as a transaction is logged)
CID—Consumer ID (typically read from data on a card presented by the consumer at checkout)
MRID—(typically read from data on a card presented by the consumer at checkout)
XID—Code uniquely corresponding to the CID or MRID.
Date—Date and preferably time of data determined by RS1 ID for the transaction.
(PID, Q, P, Cat)—The Product ID, PID, the quantity of product items, Q, the price of each product item in the consumer's purchase transaction, P, and the Category, Cat. The ellipses “ . . . ” indicate that the (PID, Q, P, Cat) field in a data view repeats so each different PID in a consumer's transaction is stored in association with a Q, a P, and optionally a Cat.

The transaction table is updated each time a consumer completes a transaction at one of the checkouts of the RS1 CS. Each such checkout communicates the transaction data so that it is stored in Transaction table 510. Typically, each such checkout transmits the data to the IP address for RS1 CS and the CPU or CPUs of that CS then store the new record in Transaction Table 510. The transaction table may also be updated at times to backfill ID data fields, such as XID.

Rewards Table 510 is shown in a design view. Table 510 shows that it includes associated fields for reward, product identifier PID, and consumer identifiers CID, MRID, XID, Provided, and Redeemed. The Provided and Redeemed fields indicate if the corresponding Reward was provided to the consumer or redeemed by the consumer. CID indicates a pre existing consumer identification, such as a number assigned by a retail store on a consumer frequent shopper card, or a portion (for example 11 of the conventional 16 digits) of an identifier on a credit or debit card.

An MRID indicates an identifier on a project based card of the type of card described herein as being distributed consumers in a retail store, or a number associated with a project/category identifier in a database. An MRID on a project based card is not initially associated with any particular consumer or purchase history. However, it may subsequently be linked to a CID when a CID and the MRID both appear in the same transaction record. An MRID may be associated by a computer system, such as central CS 10, when a customer defines for the customer's purchase transaction data a new category. The XID is a code be associated with a CID or an MRID. The XID code and a URL may be provided to the consumer associated with the CID or MRID so that the consumer may log on to the URL using the code in order to view and categorize the consumers purchases. The Provided and Redeemed fields preferably are boolean fields indicating yes or no.

ID table 530 is shown in design view. Table 530 shows that it includes fields for Retail Store ID, RSID, Consumer Identification, CID, Machine Readable Identification, MRID, Code ID, XID, and Category, Cat.

Recipe Table 540 is shown in design view. Table 540 includes fields for category, Cat, recipe, Recipe, compliance rules, Compliance Rules, and PIDs. The recipe in each record corresponds to the name for a set of PIDs required to complete a particular type of project, within a Category. The compliance rules specify project related rules, such as building code requirements for products employed in the corresponding project. The “PID1, . . . PIDn” field indicates storage of product identifications of products required to complete that type of project. Alternatively, this field may be populated with product categories, since several brands of the same category of product may be suitable for any particular recipe. In that case, separate tables could link the PIDs to categories.

The fields of the same field name in the various tables provide links relating the data in Tables 510, 520, and 530 to one another.

In operation, RS1 CS logs transaction data in Transaction table 510 upon receipt of transaction information from the POS terminals or checkouts. It also checks ID table 530 for IDs related to the CID, MRID, received with the transaction to update each transaction record with the related IDs, including missing CID, MRID, and also XID. RS1 CS preferably receives the CID, MRID, PID, and Reward data in Rewards table 520 from central CS 10, and it reports back to central CS 10 rewards provided and redeemed. Alternatively, RS1 Cs can run algorithms for determining from its transaction logs in table 510 and stored targeting rules what Rewards to associate with either a CID or MRID, or combination of CID or MRID and a PID. When RS1 CS notes a match from a purchase transaction at for example Checkout2 with a record in the Rewards table, it updates that record in that table. For example, if transaction data from Checkout2 meets a CID and PID criteria in a record in table 520, and the record indicates that the Reward was not provided, then table 520 instructs Checkout2 to print the Reward, such as a coupon for cents off a subsequent purchase of the product having the PID. If table 520 shows that the reward was provided, then RS1 CS instructs Checkout2 to include the amount of the redemption specified in the Reward to the concurrent purchase transaction so that the consumer obtains the discount on the purchase of the item specified in the coupon the consumer is redeeming. Preferably, central CS 10 transmits to RS1 CS the XID associated with each record in ID table 530. That is, central CS 10 may transmit to RS1 CS an XID in association with at least one other of the CID and MRID, and RS1 CS updates its table 530 accordingly. In addition, concurrent with a transaction specifying a category (or project), RS1 CS may compare the products being purchased with the recipe or recipes for that category in table 540 and compliance rules to determine if the products being purchased satisfy the compliance rules. RS1 CS may generate a notification of compliance or non compliance for product/category and or product/recipe, and instruct the corresponding Checkout to print or otherwise notify the purchaser of the compliance or non compliance of the product being purchased for corresponding recipes. RS1 CS provides to a consumer, preferably during a transaction at a checkout, an XID. RS1 CS indicates that the provided XID allows the consumer to online access for example via a specified URL the consumer's purchase data for purchases from that retail store.

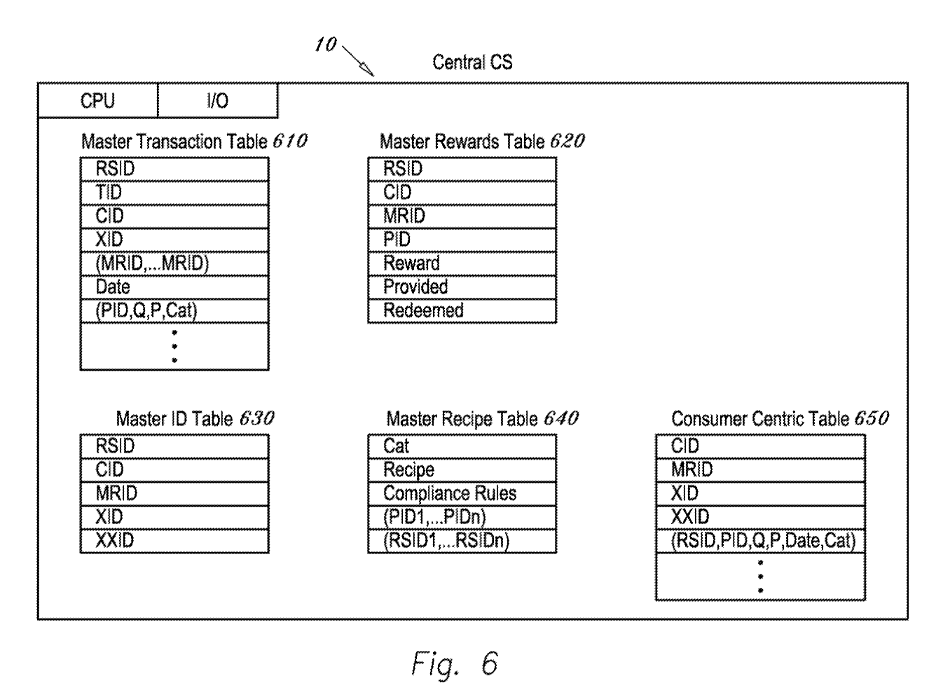

FIG. 6 shows central CS 10 including at least one CPU and I/O allowing users to interact with central CS 10. Central CS 10 may consist of one or more general or specialized CSs communicating with one another.

FIG. 6 shows central CS 10 includes master tables for records from many stores corresponding to the tables 510-540 in RS1 CS, in addition to other tables. The master tables include Master Transaction Table 610, Master Rewards Table 620, Master ID table 630, and Master Recipe table 640. In addition, central CS 10 stores Consumer Centric table 650 and Consumer Category Definition table 660.

Master tables 610 to 640 store the same data as tables 510-540, but store that data from many stores and therefore where needed also store RSID to distinguish the retail store in which the transaction data for each record originated.

Table 640 may include another field “RSID1, . . . RSIDn” indicating the retail stores to which each recipe record is applicable; some recipes may be inapplicable at a retail store. Each store may be given the option of opting out of a particular category or recipe in which case that store's RSID is not included in the corresponding record in table 640. Similarly, table 620 may include another field “RSID1, . . . RSIDn” indicating the retail stores to which each reward is applicable; some rewards may be inapplicable at a retail store. Each store may be given the option of opting out of a particular reward in which case that store's RSID is not included in the corresponding record in table 620.

Consumer Centric table 650 rearranges the data from the transaction table 610 so that all purchase data for a XID from a specified (by RSID) retail store is stored in one record. This record includes both XID and XXID identifiers. The XID is the code provided by the retail store to the consumer allowing the consumer to log on to a web site where the consumer can access the data in the corresponding record in table 650 (either with or without transmission of other information, such as a username, to a computer system running the web site). Preferably, central CS 10 generates that code for each CID and provides it to the RS. Alternatively, central CS 10 generates a code indicating the RS and instruct RS1 CS to include that code and an XID, so that central CS 10 can determine and distinguish between consumers obtaining codes from different RSs. The reason for table 650 is to provide efficient data retrieval so that a consumer can promptly access their transaction records via a web site interacting with central CS's database of transaction records. The ellipses “ . . . ” in table 650 indicate additional sets of “(RSID, PID, Q, P, Date, Cat)” that are each the transaction data for a transaction in the retail store associated with that RSID.

Consumer Category Definition table 660 contains ID of consumer via XID or XXID, and also fields for Category and Category Definition. These field definitions may be defined by the consumer as part of interactive functionality of a web site at which the consumer can access the consumer's data stored in table 650.

FIG. 7 shows one side of a MRID card 700 including a magnetic strip or bar code 710, and MRID code 720, and printed labels for fields for the consumer to write in project name and consumer name, 730. Magnetic strip or bar code 710 can store in machine readable form the MRID.

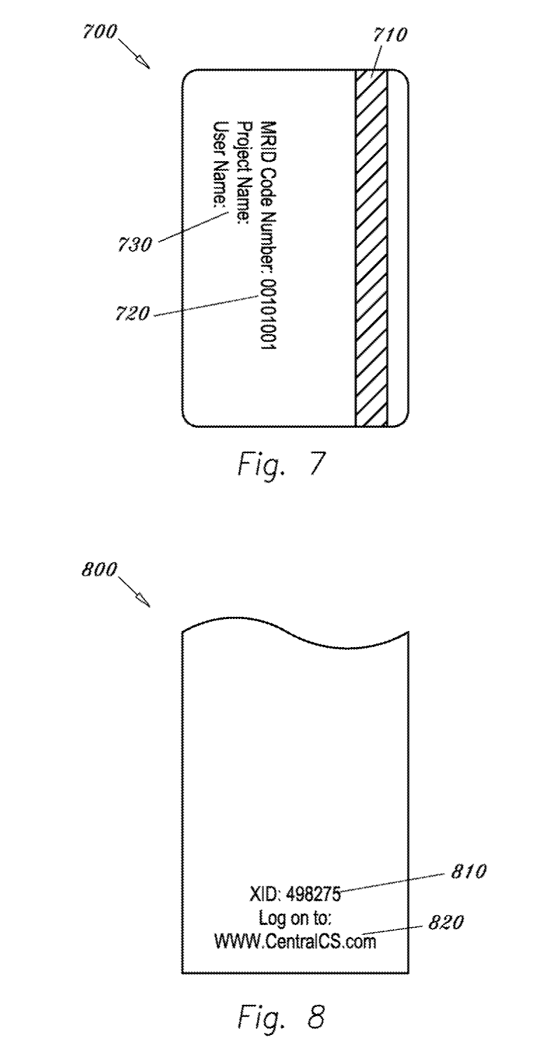

FIG. 8 shows a register tape 800 for a transaction, including print specifying XID 810, and print specifying a URL 820. URL 820 is the URL at which the consumer can use the XID code to log on to a web site that can display the consumer's purchase transaction data.

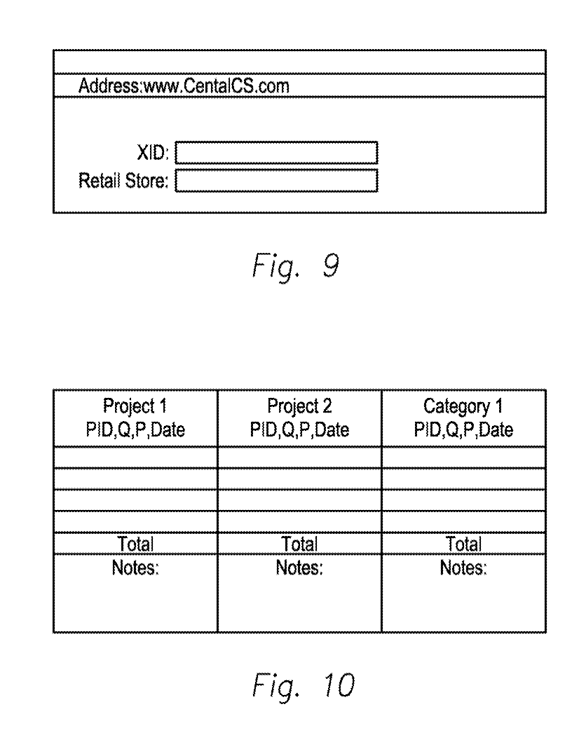

FIG. 9 shows a log on for ane exemplary web site, www.CentralCS.com.

FIG. 10 shows an example of one view of what the exemplary web sight might show after logging on. FIG. 10 shows purchased products organized by category or project, lists a total for each, and includes fields for notes by the consumer and notes about compliance for specified recipes. Not shown are functionality allowing for naming by the consumer of categories or projects, and reassignment by the consumer of product purchases between categories/projects. Also not shown, are views enabling the consumer to associate multiple XIDs with one another; the XIDs for the same consumer obtained from different retail organizations.

System Operation

In operation, all of the data and functions of central CS 10 may be performed by any CS, such as RS1 CS. In that case, RS1 CS stores the additional data structures and code described for central CS 10.

The preferred embodiment is with respect to central CS 10 performing data analysis and communicating with plural RS CSs in order to provide the RS CSs with data for the Rewards tables, and for data loaded into Recipe table 640 to be downloaded to Recipe tables 540. Central CS 10 also runs web sewer software providing the web site where consumers can use their XIDs and retail store names or addresses to log in and examine and organize their transactions data. For example, central CS 10 may run code determining a correlation of a consumer's product purchase history based upon Category, Recipe, and to recency of purchase (defined as the difference from current date to date of purchase) by product category or by PIDs associated with that category and recipe. Central CS does so using the data for Category, Recipe, and PIDs or corresponding product category identifications for a record in table 640. For correlations above a predetermined threshold, central CS 10 may associate a reward with associated XID or XXID for purchase of a product or some product in a product category for the corresponding recipe that the consumer has not recently purchased. An example of a recency correlation is a value of 1 if purchased in the last month and a value of zero if not purchased in the last month. The correlation for example may be based upon a function that has a value of the sum of the number of products for the recipe purchased in the last month divided by the total number of products in a corresponding recipe. A predetermined value is for example 0.5 so that if more than one half of the products associated with a recipe have been purchased within the last month, central CS 10 generates a reward record in table 620 including the RSID, CID, and MRID for the consumer, and a reward for purchase by the consumer of at least one product not purchased within the last month and associated with the recipe.

For a specific example, central CS 10 may depend a reward upon the customer purchasing and associating with a category or project, 2 of the 3 product items specified in a recipe for completing the specified project, or a project in the specified category. Central CS 10 would then generate a record in rewards table 620 for the corresponding CID or MRID for a reward on purchase of, for example, a specified brand for the as yet not purchased third product. For example, central CS 10 may generate a purchase incentive for “Jones brand” roofing fasteners (nails or screws of the like), if a consumer purchased shingles, and tar, along with many other products unrelated to roofing, and the consumer had specified as a category or project for that purchase, roofing, specified either online via the web site or via use of an MRID card indicating roofing category or project. In table 6520, central CS 10 initializes the values for Reward and Provided to “no”. The reward may be a discount on purchase of the specified product, or it may be a redeemable voucher that may be redeemed on yet subsequent purchase. In addition, Central CS 10 may determine whether the consumer's products associated with the purchase, by size, description, and relative quantities, meet compliance rules specified in table 640 associated with a corresponding project. Central CS 10 may act on that determination by saving in the Rewards table 520, for example in the Rewards field, information for presentation to the consumer about compliance.

Once central CS 10 processes transaction data, it uploads the data for each RS based upon RSID to the corresponding RS CS, such as RS1 CS for retail store 1. It also preferably uploads to the corresponding RS CSs data for that RSID from Recipe table 540. It may also generate and upload new XIDs for each CID in its transaction data table for which no XID exists.

RS1 CS receives the Rewards and Recipes table data and loads it into its Rewards table 520 and Recipe table 540. It may also receive a new XID in association with a MRID or CID, and updates its ID table 530 with the new XIDs.

A consumer enters Retail Store 1 and acquires product items and optionally an MRID card from some department. At a checkout, the consumer provides either the MRID card or some other form of machine readable identification (credit card, shopping card, etc, having a readable identification code), and the acquired product items. The checkout reads the consumer and product IDs and optional MRID. The checkout transmits that data to the RS1 CS's memory. RS1 CS determines if the transaction data matches any record in its Rewards table 520. If yes, it transmits the Rewards data to the checkout. If the rewards data is a current discount, then the total for the transaction is discounted. If the reward data is a purchase offer incentive, the checkout prints the purchase offer incentive (coupon) so the consumer can take that with them. If the Rewards data is information about compliance or other information, the checkout prints that so that the consumer can take that printed information with them.

RS1 CS also determines if there is an XID associated with the MRID or CID and if so it has the checkout print that XID during the transaction so that the consumer can take that information with them. Preferably, the checkout also prints the URL for a web site where the XID may be used by the consumer to obtain access to the consumer's transaction data. Alternatively, RS1 CS may advise the consumer to use the consumer's CID to access the web site.

In one embodiment, RS1 CS transmits the consumer's transaction data to central CS 10 during the consumer's transaction at the checkout, central CS 10 determines suitable rewards based upon that data, and transmits the rewards back to RS1 CS during the consumer's transaction, and the checkout then responds accordingly as indicated above to provide the reward.

The consumer then logs on to specified web site 900, preferably by entering an identification (CID or XID or MRID) and the name of the retail store. Thereafter web site 900 displays to the consumer purchase data associated with the identification presented by the consumer.

Web site 900 may also present to the consumer another screen prompting the consumer to enter the CID or XID or MRID from another retail store, and the other retail store name. If the consumer provides that information, it links otherwise unrelated purchase transaction data to a single individual or household. If the consumer provides that information, central CS 10 links that information for example by changing one of the two corresponding XXIDs to be the same as the other XXID in ID table 630. Central CS 10 may also revise each of the two records in table 630 by adding an additional field that stores both the RSID and XID for the consumer's record for the other store. Thereafter, central CS 10 may associate data from both retail stores purchased by the same consumer and display to that consumer the combined data set when the consumer logs on to web site 900. The same concept may be extended to any number of retail stores for the same consumer for which central CS 10 stores data.

The web site is preferably configured to allow the consumer to define categories and recipes or select from a list of categories and recipes. Once the consumer finishes a session, that is, logs off, or the session variable associated with the web page transmitted to the consumer expires, or the consumer transmits an update request, central CS 10 updates its data record for that consumer to indicated the changes to category and recipe and association of data to category and recipe specified by the consumer. Central CS 10 thereafter runs code to determine new rewards to provide to the consumer based upon the revised consumer category and recipe data, and updates its Rewards table 620 accordingly.

In addition, central CS 10 may be configured to display or provide the rewards to the consumer interactively via the consumer's CS with web site 900. If the reward is a coupon, it may be displayed so that the consumer can print it to paper, save it to a portable electronic device (cell phone or PDA or laptop computer).

Central CS 10 may incorporate the records for which the consumer has associated XIPs, CIDs, and MRIDs with one another, when determining whether the consumer's transaction history, including product purchase history, meets targeting criteria indicating associating a reward with the consumer. If so, central CS 10 may store and then transmit a reward record to one or more of computer system's having RSIDs (that is, different retail stores) associated with the consumer's XXIP, XIPs, CIDs, and MRIDs.

In one alternative, central CS 10 sends the same rewards records to all of the RS CSs having RSIDs associated with the consumer's linked records.

In another alternative, central CS 10 selects only one or a subst of RSIDs to which to transmit any particular reward record. In this alternative, central CS 10 may select the one or subset of RSIDs based upon stored criteria, such as a ranking of RSIDs, or the consumers selection of a preferred store from which to receive rewards. In this regard, the foregoing web site may be configures to prompt the consumer for a retail store identification from which the consumer prefers to receive rewards, such as coupons and the like.

1. A computer network for enabling a consumer to categorize products in the consumer's transaction data and to determine communications for said consumer based at least upon the consumer's categorizations, comprising;
a first RS CS, said first RS CS including at least one CPU for processing data, at least one checkout station for processing purchase transactions by consumers, and memory for storing data for said purchase transactions by said consumers, wherein said data for said purchase transactions includes, in association with one another for each purchase transaction, PIDs for items purchased, price of each item, quantity of each product item purchased, date, and at least one of CID and MRID;
an interface wherein a consumer can use said interlace to log in, using an XID code associated in a database with at least one of said CID and said MRID, to thereby access data for only those purchase transactions by said consumer, and wherein said consumer can use said interface to assign and reassign at least one of a category and a recipe to PIDs associated with purchase transactions by said consumer, and said interface is programmed to store the consumer's assignments to a database; and
a targeting algorithm implemented in code on a CS for determining communications for presentation to said consumer, wherein said targeting algorithm depends targeting at least in part upon the consumer's assignments to at least one of category and recipe, of PIDs associated with purchase transactions by said consumer.

2. The network of claim 1 wherein said interface enables a consumer to associate with one another, a CID or MRID associated with the consumer's product purchases in said first retail store with a CID or MRID associated with the consumer's product purchases in a second retail store, and said interface stores the association in said database; and
wherein said targeting algorithm depends targeting at least in part upon the consumer's assignments to at least one of category and recipe, of PIDs associated with purchase transactions by said consumer in said first retail store and said second retail store.

3. The network of claim 1 further comprising:
a central CS
a second RS CS;
wherein said central CS controls access to said database, implements said targeting algorithm, and transmits to said first RS CS in association with at least one of said CID and said MRID, communications intended for said consumer;
and wherein said first RS CS and said second RS CS transmit data for said purchase transactions by consumers to said central CS.

4. The network of claim 3 further comprising a computer operated by said consumer to connect to said interface; and
wherein said interface is a web site run by web server software on said central CS.

5. The network of claim 4 wherein said purchase transactions are stored in a transaction table in said memory; and
wherein said purchase transactions in addition to purchase transactions from other retail stores are stored in a master transaction table in a database of said central CS.

6. The network of claim 5 wherein said database of said central CS also stores a consumer centric table storing, in association with at least one of a XID, MRID, XID, and XXID indicating a consumer, data for plural purchase transactions by said consumer.

7. The network of claim 6 wherein the same XXID is associated with a first purchase transaction associated with an RSID for said first RS CS, and a second purchase transaction associated with an RSID for a second RS CS, thereby linking purchase transactions by the same consumer in different retail stores to one another.

8. The network of claim 1 further comprising code for determining correlations of purchases of a specified product having a specified PID to PIDs of a template for a project, adding said specified PID to said template when said correlation exceeds a predetermined or relative value, and removing said specified PID from said template when said correlation is below a predetermined or relative value.

9. The network of claim 1 wherein said targeting algorithm excludes data associated by said consumer with a specified project for use in determining whether to present a certain communication to said consumer

10. The network of claim 1 wherein said targeting algorithm includes only data associated by said consumer with a specified project for use in determining whether to present a certain communication to said consumer.

11. The network of claim 1 wherein said targeting algorithm excludes data associated by said consumer with a specified category for use in determining whether to present a certain communication to said consumer

12. The network of claim 1 wherein said targeting algorithm includes only data associated by said consumer with a specified category for use in determining whether to present a certain communication to said consumer.

13. A computer network method for enabling a consumer to categorize products in the consumer's transaction data and to determine communications for said consumer based at least upon the consumer's categorizations, comprising:
providing a first RS CS, said first RS CS including at least one CPU for processing data, at least one checkout station for processing purchase transactions by consumers, and memory for storing data for said purchase transactions by said consumers, wherein said data for said purchase transactions includes, in association with one another for each purchase transaction, PIDs for items purchased, price of each item, quantity of each product item purchased, date, and at least one of CID and MRID;
a consumer using an interface to log in, using an XID code associated in a database with at least one of said CID and said MRID, to thereby access data for only those purchase transactions by said consumer;
said consumer using said interlace to assign and reassign at least one of a category and a recipe to PIDs associated with purchase transactions by said consumer;
said interface storing the consumer's assignments to a database;
determining, using a targeting algorithm implemented in code on a CS, communications for presentation to said consumer; and
depending, using said targeting algorithm, targeting at least in part upon the consumer's assignments to at least one of category and recipe, of PIDs associated with purchase transactions by said consumer.

14. The method of claim of claim 13 wherein said interface enables a consumer to associate with one another, a CID or MRID associated with the consumer's product purchases in said first retail store with a CID or MRID associated with the consumer's product purchases in a second retail store, and said interlace stores the association in said database; and
wherein said targeting algorithm depends targeting at least in part upon the consumer's assignments to at least one of category and recipe, of PIDs associated with purchase transactions by said consumer in said first retail store and said second retail store.

15. The method of claim 14 further comprising;
providing a central CS
providing a second RS CS;
using said central CS for controlling access to said database, implementing said targeting algorithm, and transmitting to said first RS CS in association with at least one of said CID and said MRID, communications intended for said consumer;
transmitting from said first RS CS and said second RS CS data for said purchase transactions by consumers to said central CS.

16. The method of claim 15 further comprising said consumer operating a computer to connect to said interface; and
wherein said interface is a web site run by web server software on said central CS.

17. The method of claim 13 wherein said targeting algorithm excludes data associated by said consumer with a specified project for use in determining whether to present a certain communication to said consumer

18. The method of claim 13 wherein said targeting algorithm includes only data associated by said consumer with a specified project for use in determining whether to present a certain communication to said consumer.

19. The method of claim 13 wherein said targeting algorithm excludes data associated by said consumer with a specified category for use in determining whether to present a certain communication to said consumer

20. The method of claim 13 wherein said targeting algorithm includes only data associated by said consumer with a specified category for use in determining whether to present a certain communication to said consumer.
